(19) United States
(12) Patent Application Publication
(10) Pub. No.: US 2006/0233345 A1
(43) Pub. Date: Oct. 19, 2006

(54) Automatic contact distributor with workflow system integration

(76) Inventors: Michael Frediani, Plainfield, IL (US); Richard Mancuso, Elmhurst, IL (US); Mark Michelson, Elburn, IL (US); Sales Kalayil, Glen Ellyn, IL (US)

Correspondence Address: WELSH & KATZ, LTD, 120 S RIVERSIDE PLAZA, 22ND FLOOR, CHICAGO, IL, 60606, US

(21) Appl. No.: 11/108,555

(22) Filed: Apr. 18, 2005

(51) Int. Cl. H04M 3/00

(52) U.S. Cl. 379/265.02

(57) ABSTRACT

A method and apparatus are provided for operating an automatic contact distributor by an organization having a plurality of agents. The method includes the steps of detecting receipt of a plurality of contacts and a plurality of workflow projects, determining a contact type of each contact of the plurality of contacts and a workflow type of each workflow project of the plurality of workflow projects and assigning a contact of the plurality of contacts to a first agent of the plurality of agents and a workflow project of the plurality of workflow projects to a second agent of the plurality of agents where the assignment of the contact and of the workflow project to the first and second agent is based upon a set of enterprise rules of the organization.

### FIELD OF THE INVENTION

The field of the invention relates to communication systems and more particularly to automatic call distributors.

### BACKGROUND OF THE INVENTION

Automatic call distributors (ACDs) are known. Such systems are typically used by organizations to serve large numbers of callers. Typically, calls are directed to a common telephone number and distributed to agents based upon some criteria (e.g., agent idle time).

ACDs can typically process both inbound and outbound calls. Typically, a controller monitors a workload of its agents. Where a workload of received calls fall below some threshold value, the controller may begin to initiate outbound calls.

In addition to placing and distributing calls, an ACD may also identify and display documents on agent terminals as an aid to processing the calls. In the case of incoming calls, the calls may be received along with dialed number identification service (DNIS) and/or automatic number identification (ANI) information. ANI may be used to identify a caller at the same instant as the call is delivered to the ACD. The controller of the ACD may use the ANI information to retrieve and display customer records on a terminal of the agent selected to handle the call at the same instant that the call is delivered to the agent.

In addition, textual information may be displayed on a terminal of the agent that guides the agent through a sales presentation. DNIS information may be used to identify an intended call target and to select an appropriate sales presentation for use by the agent based upon the intended call target.

In recent years, the functionality of ACDs has been expanded to also include processing contacts through the Internet. Because of the ability to also process calls through the Internet, the older terminology of automatic call distributor has been changed to automatic contact distributor to reflect the expanded capability of such equipment.

While such equipment is useful, it is still too limited in its ability to process transactions in a broader context. Accordingly, a need exists for more flexible automatic contact distributors.

### SUMMARY

A method and apparatus are provided for operating an automatic contact distributor by an organization having a plurality of agents. The method includes the steps of detecting receipt of a plurality of contacts and a plurality of workflow projects, determining a contact type of each contact of the plurality of contacts and a workflow type of each workflow project of the plurality of workflow projects and assigning a contact of the plurality of contacts to a first agent of the plurality of agents and a workflow project of the plurality of workflow projects to a second agent of the plurality of agents where the assignment of the contact and of the workflow project to the first and second agent is based upon a set of enterprise rules of the organization.

### BRIEF DESCRIPTION OF THE DRAWINGS

FIG. 1 is a block diagram of an automatic contact distributor for processing workflow projects under an illustrated embodiment of the invention.

### DETAILED DESCRIPTION OF AN ILLUSTRATED EMBODIMENT

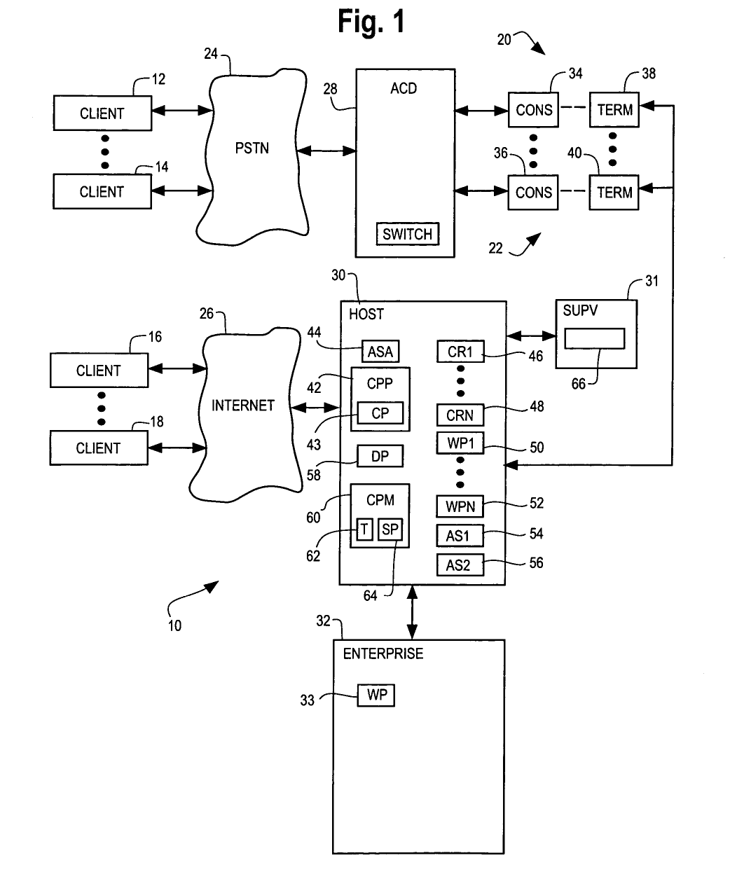

FIG. 1 depicts an integrated workflow and contact processing system 10, shown generally in accordance with an illustrated embodiment of the invention. In general, the system 10 may be used by any of a number of different organizations (e.g., commercial, environmental, political, etc.) to advance the agenda of the organization.

Under illustrated embodiments, the system 10 may process contacts (e.g., switched circuit voice calls, voice-over-Internet-calls (VoIP), e-mails, instant messaging (IM), etc.) in a conventional manner. However, the integrated system 10 may also process workflow projects of the organization as described in more detail below.

Turning first to the processing of contacts, an explanation will be provided of the operation of the system 10, in general. Following the explanation of the system 10 in the context of processing contacts, a description will be provided of how workflow projects may be processed by the system 10.

In order to promulgate the agenda of the organization with its clients 14, 16, the organization may publish, by advertising or otherwise, one or more telephone numbers, universal resource locators (URLs), instant messaging (IM) addresses or e-mail addresses that identify communication paths to the organization. Clients 12, 14, 16, 18 may use these communication path identifiers to initiate contacts with the organization. Alternatively, the organization may purchase communication path identifiers of potential clients and place outgoing contacts directed towards the clients 12, 14, 16, 18.

In this regard, contacts with clients 12, 14 through the PSTN 24 may be processed by an ACD 28. Contacts with clients 16, 18 through the Internet 26 may be processed by a host 30.

In either case, contacts set up through the ACD 28 or host 30 may be delivered to an agent working though a workstation 20, 22. Contacts through the PSTN 24 may be delivered through the ACD 28 to a console 34, 36 of the workstation 20, 22. Contacts through the Internet 26 may be delivered through the host 30 to a terminal 38, 40 of the workstation 20, 22.

In general, as each contact is detected (i.e., with a client 12, 14, 16, 18), a project processor 42 may open a contact record 46, 48 and assign a unique project identifier to the contact that may also be used as the record identifier. Within the project record 46, 48, the contact processor 42 may include any contact associated information that helps a comparison processor 43 within the project processor 42 classify the call into one or more project types. In the case of calls through the PSTN 24, DNIS and ANI information may be able to identify the intended call destination and caller.

Where the organization uses different telephone numbers for different subject matter (e.g., the organization is a department store and the telephone numbers identify different departments), the DNIS information may be use (e.g., by itself) to determine a type of call involved. In addition, ANI may be used to identify the caller and to identify client records. The client records may be used to further clarify a subject matter and type of call.

Similarly, contacts with clients 16, 18 through the Internet may be classified to determine a type of call based upon other categories of contact associated information (e.g., a source universal resource locator or indicator (URL or URI), e-mail address, IM address, etc.). If the organization should provide a website, then any webpages visited by a client 16, 18 in advance of the contact may be further used to identify a subject matter and type of contact. As with contacts through the PSTN 24, the call processor 42 may open a file 46, 48 for contacts through the Internet, including any contact associated information.

Once a contact type is determined for a contact, the contact may be transferred to an agent selection application 44. The agent selection application 44 may function to identify an agent 20, 22 to handle the contact. Agent selection may be based upon any agent criteria (e.g., longest available, best skilled for the call type, etc.). Under one illustrated embodiment, the determined call type may be compared with a set of skills 54, 56 for each agent 20, 22 to identify an agent best qualified to handle the contact.

Once an agent is identified, the contact may be transferred to the selected agent 20, 22. In the case of a contact through the PSTN 24, the contact may be transferred to a console 34, 36 of the agent 20, 22 via operation of a switch. In the case of contact through the Internet, the agent selection application 44 may transfer an Internet path identifier to the terminal 38, 40 of the agent 20, 22 along with instructions to the terminal to activate the appropriate communication channel (e.g., VoIP, IM, etc.) that, in turn, forms the communication channel.

In addition to transferring the contact to the selected agent 20, 22, the agent selection application 44 may also transfer an identifier of the selected agent and contact record to a display processor. The display processor 58 may use the identifier of the client from the contact record to retrieve any client records from an associated database and display the client records on the terminal 38, 40 of the agent 20, 22 at the same instant that the contact is delivered.

In general, workflow may be processed in a somewhat similar manner. In this regard, exceptions in enterprise workflow may be detected by an enterprise processor 32 and formed into workflow projects.

As used herein, the term “workflow project” means an activity related to the internal workflow of the enterprise. A workflow project is a work assignment that results from an exception to workflow rules of the organization. A workflow project is primarily related to the internal workings of the organization even though the project may result in a call to an outside entity as an ancillary part of the project.

For example, if the organization were a telemarketing organization that sells products, then the workflow would include everything between the telemarketer and the shipping of the product, but not the telemarketer or shipper. The workflow, in this case, would proceed under a set of organizational rules that provide a set of minimum requirements for processing an order.

For example, the organizational rules may require that every entry field of an order form be accurate and complete for the order to be processed. If an order form were to contain an incorrect zip code, then the incorrect zip code would be an exception to the organization rules that would have to be corrected in order to complete the order. Under illustrated embodiments of the invention, exceptions may be assigned to agents 20, 22 for handling as separate workflow projects.

In any case, where an exception to the organizational rules is detected, the enterprise host may encapsulate the details of the exception into a record 33 that describes the workflow project and request assignment of an agent 20, 22 to handle the exception. To request processing of the workflow project, the enterprise processor 32 may first determine a type of exception involved and/or simply transfer an agent request to project processor 42 within the host 30. The agent request may include an indicator of the type of workflow request (and path to the record 33) or the enterprise processor 32 may transfer the entire record 33 to the project processor 42 and allow the agent project processor 42 to determine the type of workflow project involved.

In the case where the project processor 42 receives the entire file 33, the comparison processor 43 project processor 42 may determine the workflow type based upon any of a number of different processes. Under a first scenario, the comparison processor 43 may determine a workflow type based upon a comparison of known pathnames with a pathname that produced the exception. Alternatively, the comparison processor 43 may determine a workflow type based upon word searching using one or more templates that characterize the workflow of the organization.

Once the project processor 42 has determined the workflow type, the project processor 42 may transfer the workflow project to the agent selection application 44. The agent selection application 44 may then proceed to select an agent to handle the workflow project. Selection of an agent may be based upon any appropriate criteria (e.g., agent idle time, agent skill in handling this type of workflow project, etc.). In the case where agent selection is based upon skill, the agent selection application 44 may select an agent 20, 22 to handle the workflow project based upon a closest match between agent skill and a subject matter identified by the workflow type of the workflow project involved.

In the case where the enterprise processor 44 simply transfers an agent request (and possibly the workflow type) to the agent selection application 44, the agent selection application 44 may return a unique project identifier to the enterprise processor 32 as an identifier of the record. The agent selection application 44 may use the agent request to identify and select an agent to handle the workflow project. As above, selection of an agent may be based upon any appropriate criteria (e.g., agent idle time, agent skill in handling this type of workflow project, etc.).

Following selection of an agent 20, 22, the agent selection application 44 may transfer the workflow project to the select agent 20, 22. Transfer of the workflow project to the selected agent may mean transfer of the unique project identifier (and path to the record 33) to the selected agent 20, 22. The agent 20, 22 may retrieve the record 33 and proceed to correct the exception. Once the agent 20, 22 has corrected the exception, the agent 20, 22 may transfer the corrected record 33 back to the enterprise processor 32 and activate a release key to signal the agent selection application 44 that the agent 20, 22 is ready for the next contact.

Under another illustrated embodiment, the assignment of contacts and workflow projects may be blended based upon a set of rules of the enterprise. For example, during periods of light loading of incoming contacts (e.g., 10% of capacity) and a relatively small backlog of exceptions, the enterprise rules may require that a relatively large proportion of agent capacity (e.g., 80%) be directed to outgoing contacts with only a relatively small proportion of capacity (e.g., 10%) directed to processing workflow projects.

Alternatively, the blending of contacts and projects may be driven entirely by queue length. For example, if a queue of incoming (or outgoing) contacts exceeds some predetermined threshold level and the queue of exceptions also exceeds some predetermined level, then the number of outgoing (or incoming) contacts may be reduced to some very low level (by not processing incoming contacts) or suspended entirely.

Under another illustrated embodiment, a project monitor 60 may monitor agent activity based upon project type. A timer 62 within the project monitor 60 may measure a time of for the handling of each project and save the project identifier, project type and the time measurement in a record created for each agent 20, 22. A statistics processor 64 may determine an average processing time for each contact type and project type of each agent 20, 22 and a group average among all the agents 20, 22.

The averages for each agent 20, 22 and the group averages of the agents 20, 22 may be displayed as a performance report 66 on a supervisors terminal 31. The performance report 66 may show a side-by-side comparision of a total number, averages and identifiers of contacts and workflow projects handled by each agent 20, 22 and group averages. Deviations between the group average and the averages of the individual agents 20, 22 may be used as an indicator of overall performance and the need for training.

A specific embodiment of a method and apparatus for processing workflow projects has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of operating an automatic contact distributor by an organization having a plurality of agents, such method comprising:
detecting receipt of a plurality of contacts and a plurality of workflow projects by the automatic contact distributor; and
the automatic contact distributor assigning a contact of the plurality of contacts to a first agent of the plurality of agents and a workflow project of the plurality of workflow projects to a second agent of the plurality of agents where the assignment of the contact and of the workflow project to the first and second agent is based upon a set of enterprise rules of the organization.

2. The method of operating an automatic contact distributor as in claim 1 further comprising determining a contact type of each contact of the plurality of contacts and a workflow type of each workflow project of the plurality of workflow projects.

3. The method of operating the automatic call distributor as in claim 2 wherein the step of assigning the workflow project to the agent further comprises selecting the agent from the plurality of agents based upon a comparison between a skills list of each of the plurality of agents and the determined type of the workflow project.

4. The method of operating the automatic call distributor as in claim 1 wherein the step of assigning the workflow project to the second agent further comprises sending a workflow project identifier to the second agent.

5. The method of operating the automatic call distributor as in claim 1 further comprising a terminal of the second agent retrieving a record of the assigned workflow project from a database based upon the workflow project identifier.

6. The method of operating the automatic call distributor as in claim 1 further comprising preferentially assigning contacts to agent over workflow projects when a contact queue exceeds a predetermined threshold level.

7. The method of operating the automatic call distributor as in claim 1 further comprising opening a workflow file for each workflow project that includes at least an identifier of the agent and an identifier of the workflow type.

8. The method of operating the automatic call distributor as in claim 7 further comprising measuring a time that each agent spends on an assigned workflow project and adding the measured time to the workflow file.

9. The method of operating the automatic call distributor as in claim 8 further comprising determining a total number of workflow projects by workflow type that each agent of the plurality of agents has handled per time period.

10. The method of operating the automatic call distributor as in claim 9 further comprising determining an average handling time by workflow type for workflow projects assigned to each agent of the plurality of agents.

11. The method of operating the automatic call distributor as in claim 10 further comprising generating an agent performance report per time period for a supervisor that shows the total number of workflow projects by workflow type handled by each agent of the plurality of agents.

12. The method of operating the automatic call distributor as in claim 10 further comprising generating an agent performance report per time period for a supervisor that includes the average handling time for each workflow type per agent of the plurality of agents.

13. The method of operating the automatic call distributor as in claim 10 further comprising generating an agent performance report per time period for a supervisor that includes side-by-side reporting on contacts and workflow projects handled by the plurality of agents.

14. A apparatus for operating an automatic contact distributor by an organization having a plurality of agents, such apparatus comprising:
means for detecting receipt of a plurality of contacts and a plurality of workflow projects; and
means for assigning a contact of the plurality of contacts to a first agent of the plurality of agents and a workflow project of the plurality of workflow projects to a second agent of the plurality of agents where the assignment of the contact and of the workflow project to the first and second agent is based upon a set of enterprise rules of the organization.

15. The apparatus for operating an automatic contact distributor as in claim 14 further comprising means for determining a contact type of each contact of the plurality of contacts and a workflow type of each workflow project of the plurality of workflow projects.

16. The apparatus for operating the automatic call distributor as in claim 15 wherein the means for assigning the workflow project to the agent further comprises means for selecting the agent from the plurality of agents based upon a comparison between a skills list of each of the plurality of agents and the determined type of the workflow project.

17. The apparatus for operating the automatic call distributor as in claim 14 wherein the means for assigning the workflow project to the second agent further comprises means for sending a workflow project identifier to the second agent.

18. The apparatus for operating the automatic call distributor as in claim 14 further comprising means within a terminal of the second agent for retrieving a record of the assigned workflow project from a database based upon the workflow project identifier.

19. The apparatus for operating the automatic call distributor as in claim 14 further comprising means for preferentially assigning contacts to agent over workflow projects when a contact queue exceeds a predetermined threshold level.

20. The apparatus for operating the automatic call distributor as in claim 14 further comprising means for opening a workflow file for each workflow project that includes at least an identifier of the agent and an identifier of the workflow type.

21. The apparatus for operating the automatic call distributor as in claim 20 further comprising means for measuring a time that each agent spends on an assigned workflow project and adding the measured time to the workflow file.

22. The apparatus for operating the automatic call distributor as in claim 21 further comprising means for determining a total number of workflow projects by workflow type that each agent of the plurality of agents has handled per time period.

23. The apparatus for operating the automatic call distributor as in claim 22 further comprising means for determining an average handling time by workflow type for workflow projects assigned to each agent of the plurality of agents.

24. The apparatus for operating the automatic call distributor as in claim 23 further comprising means for generating an agent performance report per time period for a supervisor that includes the total number of workflow projects by workflow type handled by each agent of the plurality of agents.

25. The apparatus for operating the automatic call distributor as in claim 24 further comprising means for generating an agent performance report per time period for the supervisor that includes the average handling time for each workflow type per agent of the plurality of agents.

26. The apparatus for operating the automatic call distributor as in claim 25 further comprising means for generating an agent performance report per time period for the supervisor that includes side-by-side reporting on contacts and workflow projects handled by the plurality of agents.

27. A apparatus for operating an automatic contact distributor by an organization having a plurality of agents, such apparatus comprising:
a project processor that detects receipt of a plurality of contacts and a plurality of workflow projects; and
an agent selection application that assigns a contact of the plurality of contacts to a first agent of the plurality of agents and a workflow project of the plurality of workflow projects to a second agent of the plurality of agents where the assignment of the contact and of the workflow project to the first and second agent is based upon a set of enterprise rules of the organization.

28. The apparatus for operating an automatic contact distributor as in claim 27 further comprising a comparison processor that determines a contact type of each contact of the plurality of contacts and a workflow type of each workflow project of the plurality of workflow projects.

29. The apparatus for operating the automatic call distributor as in claim 28 wherein the agent selection application further comprises a skills list for selecting the agent from the plurality of agents based upon the determined type of the workflow project.

30. The apparatus for operating the automatic call distributor as in claim 27 further comprising that threshold values that causes the agent selection application to preferentially assign contacts to agent over workflow projects when a contact queue exceeds a predetermined threshold level.

31. The apparatus for operating the automatic call distributor as in claim 27 further comprising a workflow file that is opened for each workflow project that includes at least an identifier of the agent and an identifier of the workflow type.

32. The apparatus for operating the automatic call distributor as in claim 31 further comprising a timer that measures a time that each agent spends on an assigned workflow project and adding the measured time to the workflow file.

33. The apparatus for operating the automatic call distributor as in claim 32 further comprising a statistics processor that determines an average handling time by workflow type for workflow projects assigned to each agent of the plurality of agents.

34. The apparatus for operating the automatic call distributor as in claim 33 further comprising a supervisors workstation that displays the average handling time by workflow type for workflow projects assigned to each agent of the plurality of agents.

35. The apparatus for operating the automatic call distributor as in claim 34 further comprising a report displayed on the supervisor terminal that provides a side-by-side report of a total number, averages and identifiers of contacts and workflow projects handled by each agent and group averages.
